(19) United States
(12) Patent Application Publication
(10) Pub. No.: US 2025/0265043 A1
(43) Pub. Date: Aug. 21, 2025

(54) TEMPLATE CREATION SUPPORT SYSTEM, TEMPLATE CREATION SUPPORT DEVICE, AND TEMPLATE CREATION SUPPORT METHOD

(71) Applicant: Hitachi, Ltd., Tokyo (JP)

(72) Inventors: Shunta FUKUMOTO, Tokyo (JP); Kiminori SUGAUCHI, Tokyo (JP)

(73) Assignee: Hitachi, Ltd., Tokyo (JP)

(21) Appl. No.: 18/882,969

(22) Filed: Sep. 12, 2024

(30) Foreign Application Priority Data
Feb. 21, 2024 (JP) 2024-024221

(51) Int. Cl. G06F 8/20; G06F 40/289

(52) U.S. Cl. CPC G06F 8/20; G06F 40/289

(57) ABSTRACT

Provided is a template creation support system capable of supporting creation of a template of a flow close to a system configuration desired to be realized by a user. There are provided a first conversion unit that converts each template of a template group into a graph including a node indicating a service and an edge indicating a relationship between services based on a dependency relationship between set resources, a second conversion unit that converts an input including information indicating a system configuration desired by a user and an operation of each component into a graph including a node indicating a service and an edge indicating a relationship between services, a search unit that searches a template of a graph close to the graph converted by the second conversion unit from among the graphs converted by the first conversion unit from the template group, and an output unit that outputs a setting item set to the template searched by the search unit.

### TECHNICAL FIELD

The present invention generally relates to a technique for supporting creation of a template.

### BACKGROUND ART

Recently, as the accuracy of a large language model (LLM) is improved, there is a trend to improve work productivity by offloading some tasks to the LLM. As a representative approach in software design development, there is an approach to input the determined specification into the LLM as a natural language and receive a desired source code as an output, thereby reducing the time to examine the grammar and manners of the development language and improving efficiency. Such a need similarly exists in system development (hereinafter, cloud development) using the cloud, and the LLM can be utilized.

In cloud development, resources of a plurality of independent services provided by a cloud vendor are connected to construct one system. At that time, the system configuration can be managed like the source code by describing the information of the resource and the parameter in the declaration type template. Creation of a template requires knowledge about individual resources and knowledge about the descriptive syntax of the template, and manual creation requires a large number of man-hours. Therefore, it is considered to cause the LLM to generate a template.

In this regard, a technique is disclosed in which a flow of a flow template specified based on a search word is compared with a flow of a flow template managed by a template search system, and a similar flow template that is a flow template defining a flow similar to the flow of the flow template specified based on the search word is specified (see PTL 1).

### CITATION LIST

### Patent Literature

PTL 1: JP 7340952 B2

### SUMMARY OF INVENTION

### Technical Problem

The accuracy of the template generated by the LLM depends on the amount of information of the prompt input to the LLM. In a case where a user has no knowledge about individual resources, there is a case where the setting items necessary for creating the template cannot be completely input to the LLM, and even in such a case, the LLM returns the template. However, such a template often does not operate as intended by the user.

That is, the template output by the LLM often does not operate due to incompleteness of setting items such as parameter inconsistency, incorrect resource definition, and insufficient resource definition, and many knowledge and man-hours are required for correction. Such a problem is a fundamental problem of the LLM, and thus occurs regardless of the type and version of the LLM.

According to the technology described in PTL 1, even if there is a difference in the background, knowledge, and the like of the user and the phrases of the search word to be used are different, a template similar to the template corresponding to the search word is searched and a necessary portion is changed, so that the development period can be shortened and the application can be efficiently developed.

However, when it is checked whether a search word or a synonym thereof is included in a flow template name, a flow template outline, or a flow template description of a flow template and a template corresponding to the search word is specified, there is a problem that a template of a flow close to a system configuration desired to be realized by a user is not specified because a relationship between services is not considered.

The present invention has been made in view of the above points, and an object of the present invention is to propose a template creation support system or the like that can support creation of a template of a flow close to a system configuration desired to be realized by a user.

### Solution to Problem

In order to solve such a problem, according to the present invention, there is provided a template creation support system that supports creation of a template in which a dependency relationship for a resource of one service among a plurality of available services to call a resource of another service is set, the template creation support system comprising: a memory unit that memorizes information of a template group in which one or more resources provided in each of the plurality of services are set, the template group collecting templates guaranteed to operate; a first conversion unit that converts each template of the template group into a graph including a node indicating a service and an edge indicating a relationship between services based on the dependency relationship between the set resources; an input unit that receives an input including information indicating a system configuration desired by a user and an operation of each component from a user terminal; a second conversion unit that converts the input received by the input unit into a graph including a node indicating a service and an edge indicating a relationship between services; a search unit that searches, from the template group, a template of a graph close to the graph converted by the second conversion unit from among the graphs converted by the first conversion unit; and an output unit that outputs a setting item set in the template searched by the search unit.

According to the above configuration, the setting item used to create the template can be presented to the user. As a result, even a user with shallow knowledge of resources can grasp necessary setting items, and thus, for example, a prompt with a larger amount of information for obtaining a template is created by the user, and as a result, a template with higher accuracy can be obtained by the LLM.

### Advantageous Effects of Invention

According to the present invention, it is possible to realize a highly convenient template creation support system. Problems, configurations, and effects other than those described above will become apparent from the following description of an embodiment.

### BRIEF DESCRIPTION OF DRAWINGS

FIG. 1 is a diagram illustrating an example of a system according to a first embodiment.

FIG. 2 is a diagram illustrating an example of a template creation support system according to the first embodiment.

FIG. 3 is a diagram illustrating an example of a template according to the first embodiment.

FIG. 4 is a diagram illustrating an example of a setting item group according to the first embodiment.

FIG. 5 is a diagram illustrating an example of graph representation according to the first embodiment.

FIG. 6 is a diagram illustrating an example of pre-processing according to the first embodiment.

FIG. 7 is a diagram illustrating an example of template conversion processing according to the first embodiment.

FIG. 8 is a diagram illustrating an example of necessary input information storage processing according to the first embodiment.

FIG. 9 is a diagram illustrating an example of template generation processing according to the first embodiment.

FIG. 10 is a diagram illustrating an example of natural language conversion processing according to the first embodiment.

FIG. 11 is a diagram illustrating an example of template graph processing according to the first embodiment.

FIG. 12 is a diagram illustrating an example of similarity ranking derivation processing according to the first embodiment.

FIG. 13 is a diagram illustrating an example of necessary input information acquisition processing according to the first embodiment.

FIG. 14 is a diagram illustrating an example of an input sentence according to the first embodiment.

FIG. 15 is a diagram illustrating an example of a prompt according to the first embodiment.

FIG. 16 is a diagram illustrating an example of a prompt according to the first embodiment.

FIG. 17 is a diagram illustrating an example of a user interface according to the first embodiment.

FIG. 18 is a diagram illustrating an example of a user interface according to the first embodiment.

FIG. 19 is a diagram illustrating an example of a user interface according to the first embodiment.

FIG. 20 is a diagram illustrating an example of a user interface according to the first embodiment.

FIG. 21 is a diagram illustrating an example of a user interface according to the first embodiment.

### DESCRIPTION OF EMBODIMENTS

### (I) (First Embodiment)

Hereinafter, an embodiment of the present invention will be described in detail. However, the present invention is not limited to the embodiment.

In order for the LLM to generate a template with higher accuracy, the template creation support system according to the present embodiment includes: a knowledge base in which templates guaranteed to operate in advance are collected; a template conversion unit that converts a template in the knowledge base into a graph including nodes and edges; an input conversion unit that converts a user's input into a graph including nodes and edges; and a search unit that compares the graphs, calculates scores indicating similarity, and then rearranges the graphs in order of similarity. Further, the template creation support system according to the present embodiment includes a configuration for searching the knowledge base for a template of a graph having high similarity with the input graph as a similar template before the input of the user directly flows to the LLM. In this regard, the related art does not have a function of specifying an existing template close to a system configuration desired to be realized by a user in consideration of connectivity between services.

In addition, since the template creation support system of the present embodiment has a configuration in which a similar template close to the system configuration desired to be realized by the user is searched and then the setting item of the searched similar template is presented to the user, the user himself/herself can complement the input information (prompt) flowing to the LLM.

A technique called retrieval-augmented generation (RAG) is known as a function itself of assisting an input necessary for the LLM using a knowledge base. However, a technique for searching a template having high similarity from a template group described in a computer language based on an input in natural language by a user in implementing RAG is not disclosed. In the present embodiment, a method is used in which two concepts having different abstraction levels, that is, an input in natural language by a user and a template described in a computer language are expressed in a form, comparable that is, mathematical graphs having nodes and edges, and the two graphs are compared. As a result, a similar template close to the system configuration desired to be realized by the user can be searched and presented, so that a prompt with a larger information amount can be created.

Notations such as “first”, “second”, and “third” in the present specification and the like are attached to identify components, and do not necessarily limit the number or order. In addition, a number for identifying a component is used for each context, and a number used in one context does not necessarily indicate the same configuration in another context. In addition, it does not prevent a component identified by a certain number from also functioning as a component identified by another number.

Next, an embodiment of the present invention will be described with reference to the drawings. The following description and drawings are examples for describing the present invention, and are omitted and simplified as appropriate for the sake of clarity of description. The present invention can be implemented in various other forms. Unless otherwise specified, each component may be singular or plural.

In the following description, the same elements are denoted by the same reference numerals in the drawings, and the description thereof will be omitted as appropriate. Furthermore, in a case where elements of the same type are described without distinguishing them, a common portion (portion excluding a branch number) among reference numerals including branch numbers may be used, and in a case where elements of the same type are distinguished and described, reference numerals including branch numbers may be used. For example, the resource definition information may be described as “resource definition information 310” in a case where the resource definition information is not particularly distinguished, and may be described as “resource definition information 310-1”, “resource definition information 310-2” in a case where the individual resource definition information is distinguished and described.

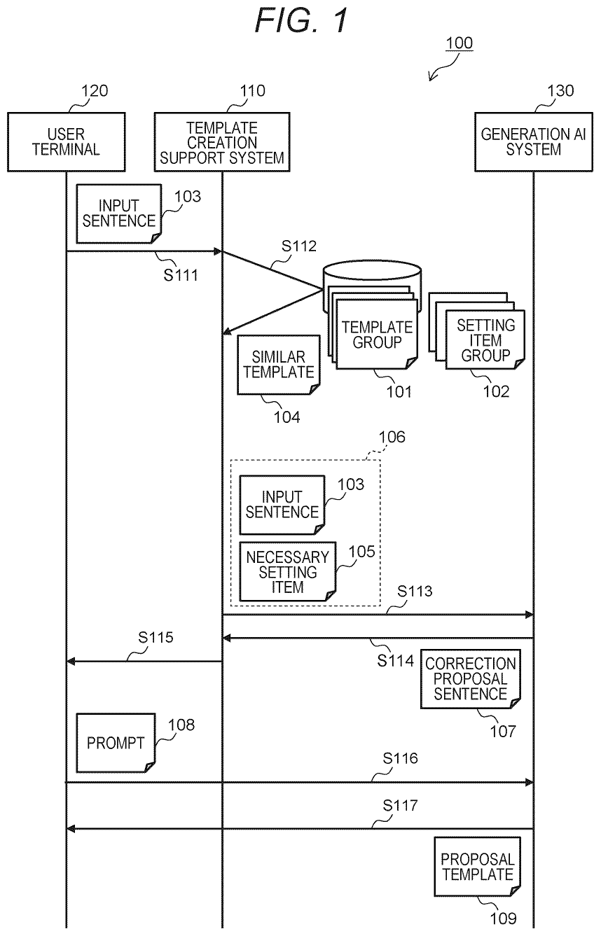

In FIG. 1, reference numeral 100 denotes a system according to a first embodiment as a whole.

The system 100 of the present embodiment includes a template creation support system 110, a user terminal 120, and a generation AI system 130, and executes processing related to creation of a template by a user. The template creation support system 110, the user terminal 120, and the generation AI system 130 are communicably connected to each other.

The template creation support system 110 includes a template group 101 and a setting item group 102.

In the template group 101, one or more templates guaranteed to operate are registered. In the template, contents in which a system configuration is coded are described. More specifically, in the template, any resource provided in each of a plurality of services available to the user is set, and a dependency relationship for a resource of one service among the plurality of services to call a resource of another service is set. The service is a plurality of independent services (cloud computing services) provided by a cloud vendor, and is various services that can use resources such as a server device, a storage device, a virtual machine, a database, and software.

The template creation support system 110 converts the template of the template group 101 into a graph including a node indicating a service and an edge indicating a relationship between services at a predetermined timing, and holds information (graph representation) of the converted graph.

In the setting item group 102, setting items necessary for the template of the template group 101 are registered in association with the template.

In step S111, the template creation support system 110 receives an input sentence 103 from the user terminal 120. The input sentence 103 includes information indicating a system configuration desired by the user and an operation of each component.

In step S112, the template creation support system 110 converts the received input sentence 103 into a graph including a node indicating a service and an edge indicating a relationship between services. The template creation support system 110 searches a graph close to the graph converted based on the input sentence 103 from the graphs converted based on the template of the template group 101, and extracts a template of the searched graph as a similar template 104 from the template group 101.

In step S113, the template creation support system 110 inputs a prompt 106 for requesting a generation AI system 130 to detect an insufficient setting item (insufficient portion) in the input sentence 103. The prompt 106 includes the input sentence 103 received from the user terminal 120, a necessary setting item 105 that is a setting item associated with the similar template 104, and an instruction to request description of an insufficient portion of the input sentence 103 in natural language.

In step S114, the generation AI system 130 receives the prompt 106 including a part or all of the input sentence 103 and the necessary setting item 105, generates a correction proposal sentence 107 from the received input sentence 103 and the necessary setting item 105, and transmits the generated correction proposal sentence 107 to the template creation support system 110. The correction proposal sentence 107 includes a content in which an insufficient portion of the input sentence 103 is translated so that the user can easily interpret the input sentence 103.

In step S115, the template creation support system 110 transmits the correction proposal sentence 107 to the user terminal 120.

In step S116, the user terminal 120 transmits a prompt 108 including the content in which the insufficient portion of the input sentence 103 is corrected by the user based on the correction proposal sentence 107 to the generation AI system 130.

In step S117, the generation AI system 130 receives the prompt 108, generates a proposal template 109, which is a template for managing a system configuration desired by the user, based on the received prompt 108, and transmits the generated proposal template 109 to the user terminal 120.

According to the above configuration, since the proposal template 109 close to the system configuration desired by the user is provided to the user, it is possible to effectively support the cloud development. Hereinafter, the present embodiment will be described in more detail.

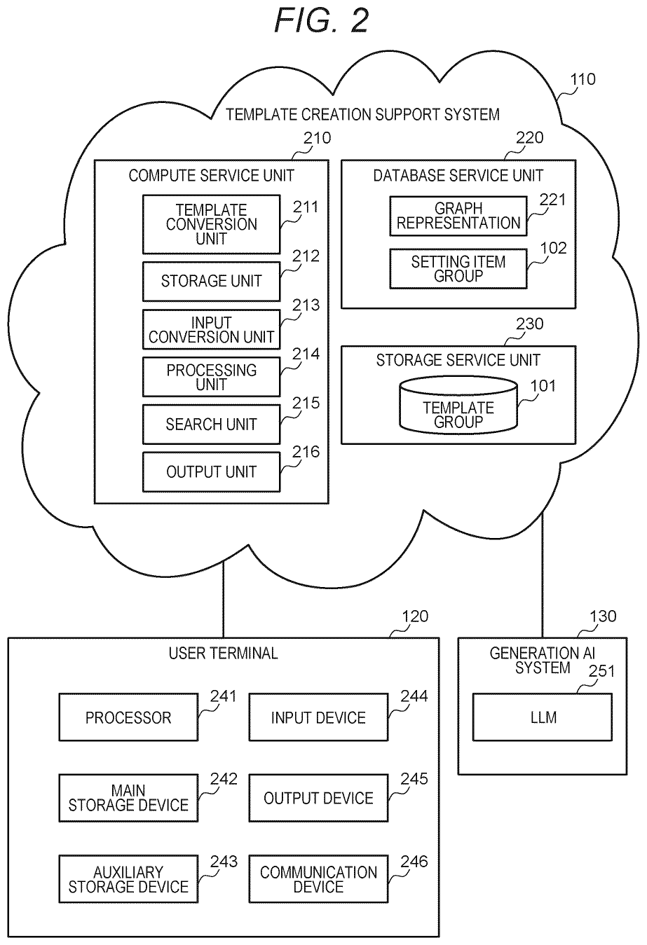

FIG. 2 is a diagram illustrating an example of the template creation support system 110.

The template creation support system 110 is, for example, a cloud system that provides a cloud computing service. Note that the cloud vendor having the cloud system and the cloud vendor used by the user to construct the system may be the same or different. The template creation support system 110 includes one or more computers, and functions (the compute service unit 210, the database service unit 220, the storage service unit 230, and the like) of the template creation support system 110 are implemented by the one or more computers reading and executing a program. In addition, one function of the template creation support system 110 may be divided into a plurality of functions, or the plurality of functions may be integrated into one function. Some of the functions of the template creation support system 110 may be provided as another function or may be included in another function. Some of the functions of the template creation support system 110 may be implemented by another computer that can communicate with the template creation support system 110.

The compute service unit 210 includes a template conversion unit 211, a storage unit 212, an input conversion unit 213, a processing unit 214, a search unit 215, and an output unit 216.

The template conversion unit 211 converts the template of the template group 101 into a graph, and generates a graph representation indicating the converted graph. The storage unit 212 stores setting items necessary for each template of the template group 101 in the setting item group 102. The input converter 213 converts the input sentence 103 in the natural language into a graph, and generates a graph representation indicating the converted graph. The processing unit 214 processes the graph (graph representation) of the template of the template group 101 so that the graph of the input sentence 103 can be more appropriately compared with the graph of the template of the template group 101. The search unit 215 calculates a score indicating the similarity between the graph converted by the template conversion unit 211 or the graph processed by the processing unit 214 and the graph converted by the input conversion unit 213, and searches the template group 101 for the similar template 104 having the highest similarity. The output unit 216 requests the generation AI system 130 to explain the insufficient portion of the input sentence 103 in natural language based on the necessary setting item 105 and the input sentence 103 associated with the searched similar template 104, and outputs the correction proposal sentence 107 obtained from the generation AI system 130 to the user.

The database service unit 220 memorizes and manages the setting item group 102 and a graph representation 221. The storage service unit 230 memorizes and manages the template group 101.

Note that the template creation support system 110 is not limited to the cloud system, and may be a computer system including one or more computers, a template creation support device (for example, a computer), or the like. In this case, the function of the template creation support system 110 may be realized, for example, by a processor reading a program stored in an auxiliary memory device in a main memory device and executing the program (software), may be realized by hardware such as a dedicated circuit, or may be realized by combining software and hardware. Furthermore, the number of each component of the hardware of the computer may be one or plural.

The user terminal 120 is a computer such as a notebook computer or a tablet terminal. The user terminal 120 includes a processor 241, a main memory device 242, an auxiliary memory device 243, an input device 244, an output device 245, and a communication device 246.

The processor 241 is a device that performs arithmetic processing. The processor 241 is, for example, a central processing unit (CPU), a micro processing unit (MPU), a graphics processing unit (GPU), an artificial intelligence (AI) chip, or the like.

The main memory device 242 is a device that memorizes programs, data, and the like. The main memory device 242 is, for example, a read only memory (ROM), a random access memory (RAM), or the like. The ROM is a static random access memory (SRAM), a non-volatile RAM (NVRAM), a mask read only memory (ROM), a programmable ROM (PROM), or the like. The RAM is a dynamic random access memory (DRAM) or the like.

The auxiliary memory device 243 is a hard disk drive, a flash memory, a solid state drive (SSD), an optical memory device, or the like. The optical memory device is a compact disc (CD), a digital versatile disc (DVD), or the like. The programs, data, and the like stored in the auxiliary memory device 243 are read into the main memory device 242 as needed.

The input device 244 is a user interface that receives information from a user. The input device 244 is, for example, a keyboard, a mouse, a card reader, a touch panel, or the like.

The output device 245 is a user interface that outputs (display output, sound output, print output, etc.) various types of information. The output device 245 is, for example, a display device that visualizes various types of information, an audio output device (speaker), a printing device, or the like. The display device is a liquid crystal display (LCD), a graphic card, or the like.

The communication device 246 is a communication interface that communicates with another device via a communication medium. The communication device 246 is, for example, network interface card (NIC), a wireless communication module, a universal serial bus (USB) module, a serial communication module, or the like. The communication device 246 can also function as an input device that receives information from another device communicably connected. Furthermore, the communication device 246 can also function as an output device that transmits information to another device communicably connected.

The function of the user terminal 120 may be realized, for example, by the processor 241 reading a program stored in the auxiliary memory device 243 into the main memory device 242 and executing the program (software), may be realized by hardware such as a dedicated circuit, or may be realized by combining software and hardware. Note that one function of the user terminal 120 may be divided into a plurality of functions, or the plurality of functions may be integrated into one function. In addition, some of the functions of the user terminal 120 may be provided as another function or may be included in another function. Further, some of the functions of the user terminal 120 may be realized by another computer that can communicate with the user terminal 120. In addition, the number of each component of the hardware of the user terminal 120 may be one or plural.

The generation AI system 130 includes one or more computers, and the function (the LLM251 or the like) of the generation AI system 130 is implemented by the one or more computers reading and executing the program.

The LLM251 is, for example, a deep learning model trained using a huge data set, and performs advanced language processing for various natural language tasks such as generation of sentences, classification of sentences, translation of sentences, and the like. For example, when the prompt 106 for requesting detection of an insufficient portion of the input sentence 103 based on the necessary setting item 105 is input, the LLM251 outputs a correction proposal sentence 107 describing the insufficient portion of the input sentence 103. In addition, for example, when the prompt 108 reflecting the content of the correction proposal sentence 107 is input as a specification in natural language of a system configuration desired by the user, the LLM251 outputs the proposal template 109 describing the system configuration of the specification.

Note that the LLM that generates the correction proposal sentence 107 and the LLM that generates the proposal template 109 will be described as the LLM251 (the same LLM), but may be different LLMs.

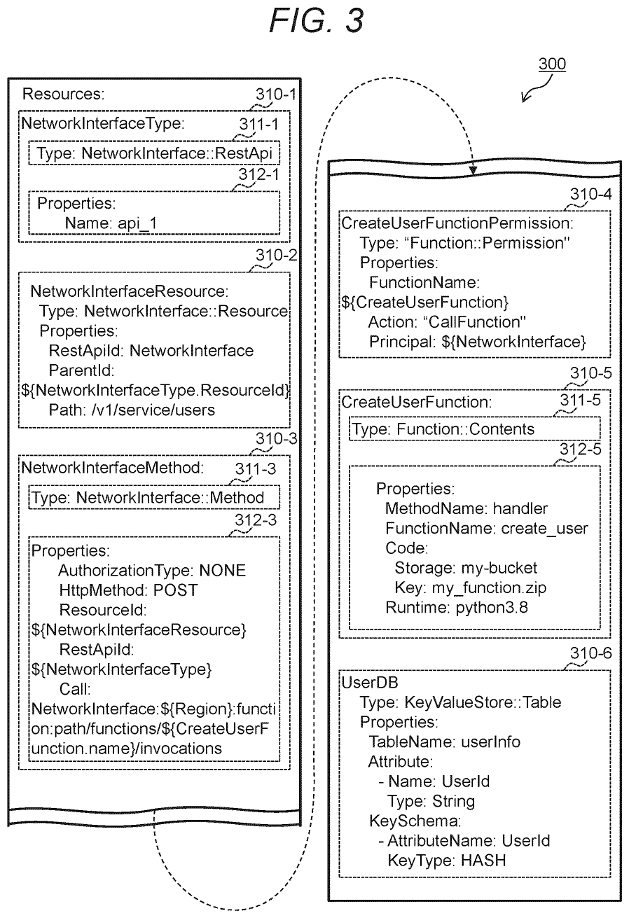

FIG. 3 is a diagram illustrating an example of a template (template 300) included in the template group 101. For convenience of description, the template 300 exemplifies a description that does not rely on various cloud computing services, but does not exclude a description corresponding to a specific cloud computing service.

The template 300 includes a plurality of pieces of resource definition information 310 in which dependency relationship between resources indicating a system configuration is defined. The resource definition information 310 includes type information 311, property information 312, and the like as information defining a resource. A service (resource type) to which a resource belongs is set in the type information 311. In the property information 312, a parameter to be a value to be passed to the template at the time of execution, reference information indicating reference to another resource in the template, and the like are set.

Each service declared in the resource definition information 310 of the template 300 has a dependency relationship through an authority for calling another service, an authorization mechanism, and the like. Focusing on this point, the template creation support system 110 specifies a relationship between resources and specifies a relationship between services from the relationship between resources. An example of the processing of specifying the relationship between services will be described later with reference to FIG. 7.

Note that, as a description format of the template, an arbitrary description format such as a JavaScript (registered trademark) Object Notification (JSON) format or a YAML Ain′t a Markup Language (YAML) format can be adopted.

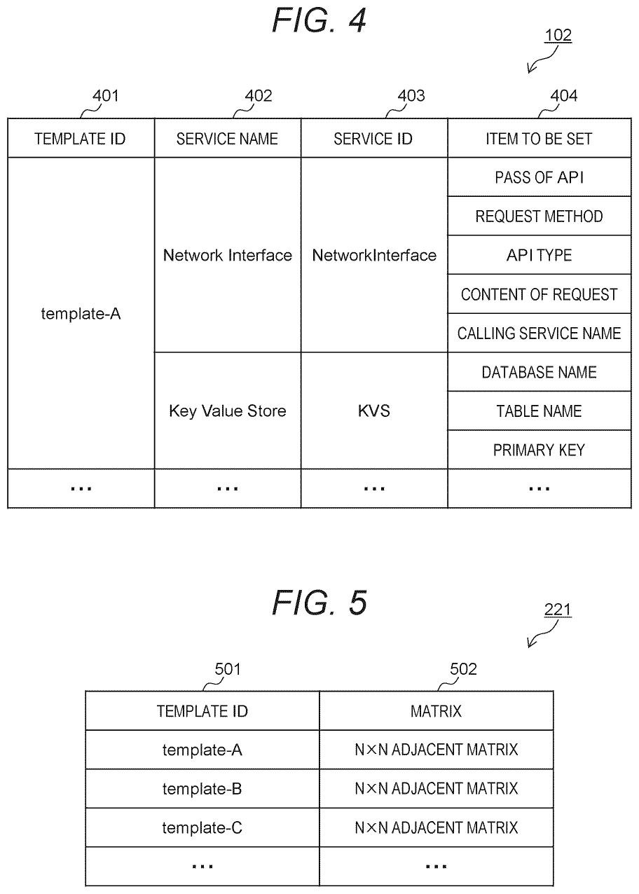

FIG. 4 is a diagram illustrating an example of the setting item group 102.

The setting item group 102 is information registered by a builder, an expert, or the like of the template creation support system 110, and includes setting items associated with a template and a service. More specifically, the setting item group 102 includes information in which a template ID 401, a service name 402, a service ID 403, and an item 404 to be set are associated with each other.

The template ID 401 is a code (identification information) allocated to identify the template. The service name 402 is a name indicating a service used in the template. The service ID 403 is a code allocated to identify the service. The item 404 to be set is a setting item that needs to be set in the service.

FIG. 5 is a diagram illustrating an example of the graph representation 221.

The graph representation 221 includes information obtained by converting a template included in the template group 101 into a graph. More specifically, the graph representation 221 includes information in which a template ID 501 and a matrix 502 are associated with each other. The template ID 501 is a code allocated to identify the template. The matrix 502 is information indicating a graph of the template, and is, for example, an N×N adjacent matrix. N is the number of services provided by the cloud vendor.

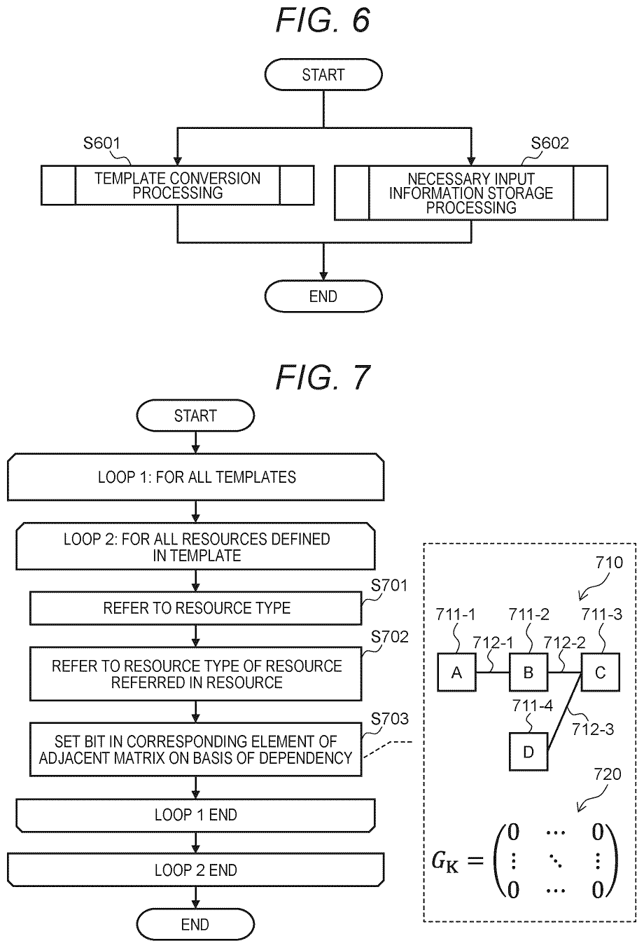

Next, processing related to creation of the template by the user r will be described with reference to flowcharts illustrated in FIGS. 6 to 13.

FIG. 6 is a diagram illustrating an example of pre-processing. The pre-processing is executed, for example, when the template creation support system 110 is constructed or when a new template group 101 is added.

In step S601, the template conversion unit 211 performs template conversion processing. In the template conversion processing, each template of the template group 101 is converted into a graph.

In step S602, the storage unit 212 performs necessary input information storage processing. In the necessary input information storage processing, setting items necessary for each template of the template group 101 are stored as the setting item group 102.

FIG. 7 is a diagram illustrating an example of template conversion processing. In the template conversion processing, attention is paid to a dependency relationship between services (resources), and the dependency relationship is graphed. Such processing enables comparison with the input sentence 103 having a different abstraction level and a different form.

The template conversion unit 211 performs the processing in steps S701 to S703 on all the templates in the template group 101 and on all the resources defined by the templates. For example, when performing the conversion processing on the template 300 of the template group 101, the template conversion unit 211 performs the processing of steps S701 to S703 in the order of resource definition information 310-1, resource definition information 310-2, resource definition information 310-3, resource definition information 310-4, resource definition information 310-5, and resource definition information 310-6. Hereinafter, a case where the resource definition information 310-3 is a processing target will be described as an example.

In step S701, the template conversion unit 211 refers to the resource type defined in the resource to be processed. For example, the template conversion unit 211 refers to the type information 311-3 of the resource definition information 310-3 and specifies the resource type “NetworkInterface”.

In step S702, the template conversion unit 211 refers to the resource type of the resource referred in the resource to be processed. For example, the template conversion unit 211 specifies the reference destination ID “CreateUserFunction” included in the resource definition information 310-3 based on the description (for example, “$ { }”) indicating the reference in the template 300, refers to type information 311-5 of the resource definition information 310-5 of the reference destination ID, and specifies the resource type “Function”.

In step S703, the template conversion unit 211 sets a bit in the corresponding element of the adjacent matrix based on the dependency relationship between resources. For example, when the resource type (first service) specified in step S701 is different from the resource type (second service) specified in step S702, it is determined that there is a dependency relationship between the services, and a bit is set in the corresponding element of the adjacent matrix. That is, for a first node indicating the first service and a second node indicating the second service, a graph is generated by subtracting an edge indicating a dependency relationship between the first node and the second node, and a weight “1” of the edge is set to a corresponding element of the adjacent matrix.

Here, the adjacent matrix will be described using a graph 710 as an example. The graph 710 includes a node 711 indicating a service and an edge 712 indicating a relationship between services.

In the template conversion processing, the template conversion unit 211 generates an N×N adjacent matrix having all services as nodes. For example, in a case where the service A is the first row and the first column, the service B is the second row and the second column, the service C is the third row and the third column, and the service D is the fourth row and the fourth column, an adjacent matrix in which only (1, 2), (2, 1), (2,3), (3,2), (3,4), and (4,3) are “1” and the others are “0” is generated. In the present embodiment, the template conversion unit 211 generates an adjacent matrix 720 (graph representation G_{K}) in which edges are drawn regardless of the direction and the number of times, and “1” is set when there is an edge between nodes, and “0” is set when there is no edge between nodes.

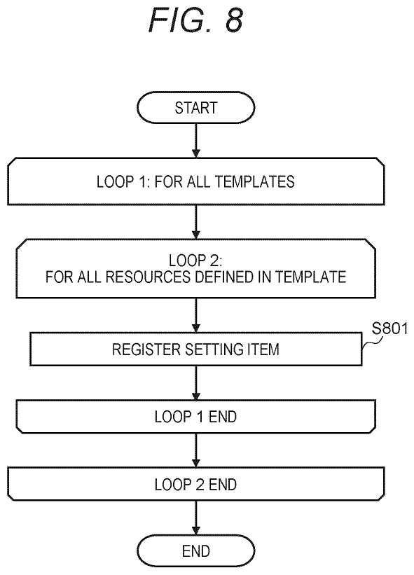

FIG. 8 is a diagram illustrating an example of necessary input information storage processing.

The storage unit 212 performs the processing in step S801 on all the templates in the template group 101 and on all the services in the templates.

In step S801, the storage unit 212 registers, in the setting item group 102, a setting item input by a builder, an expert, or the like of the template creation support system 110 in association with a template and a service via a predetermined computer (not illustrated).

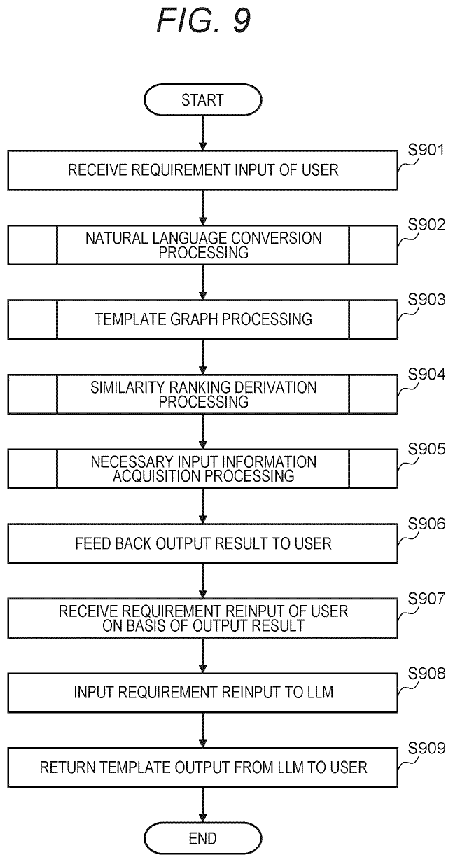

FIG. 9 is a diagram illustrating an example of template generation processing.

In step S901, the compute service unit 210 receives the input sentence 103 (requirement input of the user) via the user terminal 120.

In step S902, the compute service unit 210 performs natural language conversion processing. In the natural language conversion processing, the input sentence 103 in the natural language is converted into a graph, and an adjacent matrix of the graph is generated.

In step S903, the compute service unit 210 performs template graph processing. When the similarity between the graph of the template and the graph of the input sentence 103 is obtained, the template graph processing is performed in order to solve the problem that if the adjacent matrix is simply subtracted, it becomes weak against the extra nodes and edges. In the template graph processing, a graph (adjacent matrix) of the template is processed.

In step S904, the compute service unit 210 performs similarity ranking derivation processing. In the similarity ranking deriving processing, a score indicating the similarity between the graph of the template and the graph of the input sentence 103 is calculated, and the similar template 104 having the highest similarity is specified from the template group 101.

In step S905, the compute service unit 210 performs necessary input information acquisition processing. In the necessary input information acquisition processing, a setting item (necessary setting item 105) associated with the similar template 104 is searched to detect an insufficient portion of the input sentence 103. Then, an insufficient portion of the input sentence 103 is detected by the LLM251 based on the necessary setting item 105, and the correction proposal sentence 107 for the user is generated.

In step S906, the compute service unit 210 transmits the correction proposal sentence 107 to the user terminal 120 (feeds back the output result to the user).

In step S907, the compute service unit 210 receives the prompt 108 (requirement reinput in which the user reinputs the requirement based on the correction proposal sentence 107 which is the output result) via the user terminal 120.

In step S908, the compute service unit 210 transmits the prompt 108 to the LLM251 (inputs a requirement reinput to the LLM251).

In step S909, the compute service unit 210 transmits the proposal template 109 to the user terminal 120 (returns the template output from the LLM251 to the user).

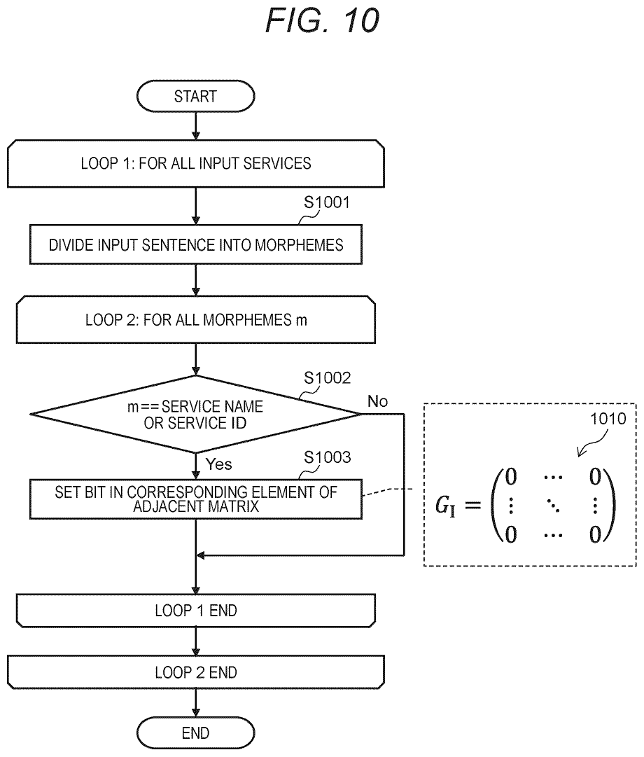

FIG. 10 is a diagram illustrating an example of natural language conversion processing. In order to obtain the similar template 104, that is, in order to search a template guaranteed to operate based on the input sentence 103 input by the user, it is necessary to put the input of the natural language into a more abstract expression. Therefore, in the natural language conversion processing, the input sentence 103 is dropped into a graph including nodes and edges and expressed as an adjacent matrix.

The input converter 213 performs the processing in step S1001 on all the services of the input sentence 103.

In step S1001, the input conversion unit 213 divides the input sentence 103 into morphemes.

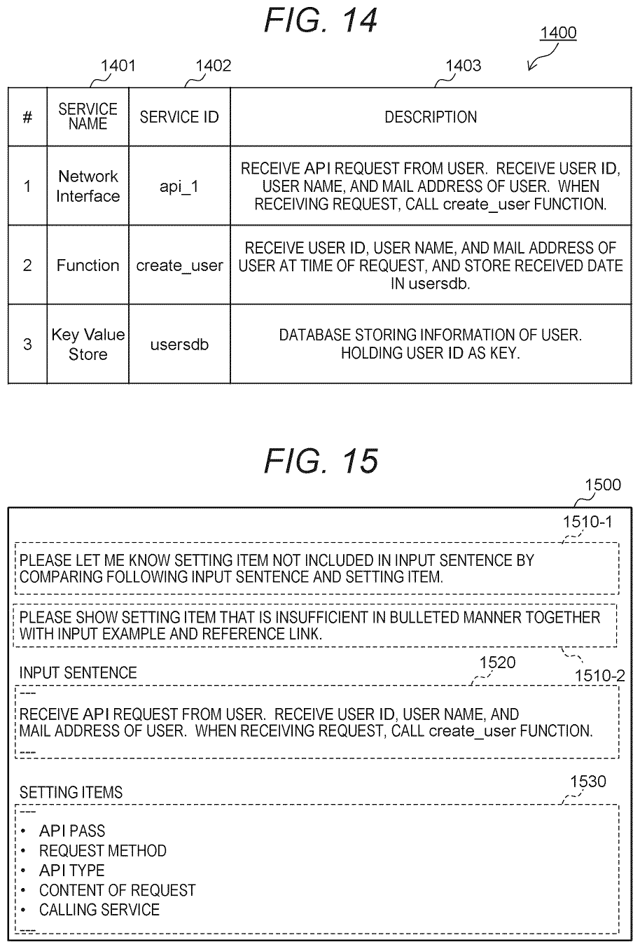

Furthermore, the input conversion unit 213 performs the processing of steps S1002 and S1003 on all the morphemes. Hereinafter, a case where the input sentence 103 is an input sentence 1400 illustrated in FIG. 14 and the service name of the service to be processed is “Network Interface” will be described as an example as appropriate.

Here, as illustrated in FIG. 14, the input sentence 103 includes, for each service, an ID of the service and an explanatory sentence of the service. In addition, since a description indicating a relationship with another service is described in the explanatory sentence of the service, a service name of another service or a service ID of another service can be included.

In step S1002, the input conversion unit 213 determines whether or not the morpheme to be processed matches a service name or a service ID of a service different from the service to be processed. The input conversion unit 213 performs the processing of step S1003 when determining that the morpheme to be processed matches the service name or the service ID, and moves the processing target to the next morpheme when determining that the morpheme to be processed does not match the service name or the service ID.

For example, in the input sentence 1400, when the service name of the service to be processed is “Network Interface” and the morpheme to be processed is “create user”, the description of the service includes a service ID “create user” of another service. In this case, the input conversion unit 213 detects another service having a dependency relationship with the service to be processed, and determines that the morpheme to be processed matches the service name or the service ID in step S1002.

In step S1003, the input conversion unit 213 sets a bit in the corresponding element of the adjacent matrix based on the service to be processed and the other service detected in step S1002. Note that, in the natural language conversion processing, similarly to the template conversion unit 211, the input conversion unit 213 generates an N×N adjacent matrix 1010 (graph representation Gr) in which all services are nodes.

As described above, the input conversion unit 213 converts the input of the system configuration at the service level into a graph focusing on the relationship between services, thereby enabling comparison with a template describing detailed parameters.

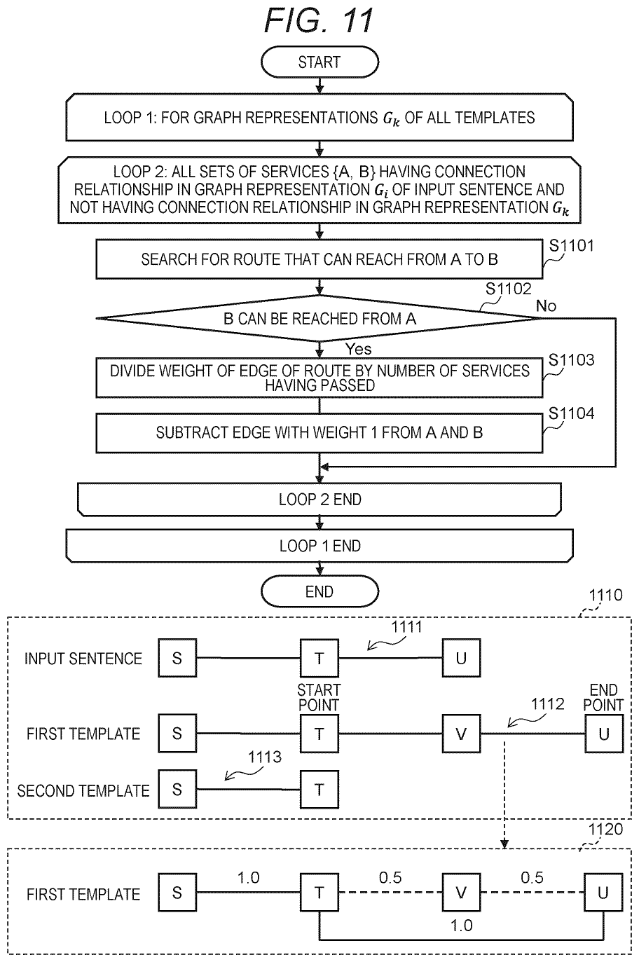

FIG. 11 is a diagram illustrating an example of the template graph processing.

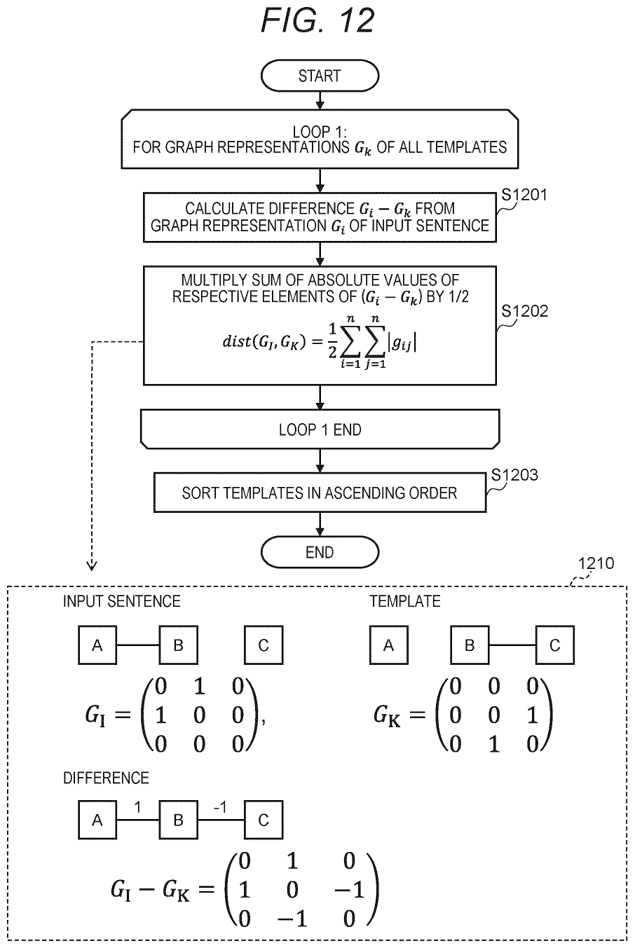

In the present embodiment, as will be described later with reference to FIG. 12, ½ times the sum of the absolute values of the respective elements of (G_{I}−G_{K}) is calculated as the score indicating the similarity between the graph representation G_{I} and the graph representation G_{K}. Therefore, in a case where the score is calculated without processing the adjacent matrix of the template, there is a case where the similarity is considered to be low if there is an extra service therebetween. Therefore, in the template graph processing, the graph (adjacent matrix) of the template is processed according to the reachability.

More specifically, the description will be given using an explanatory graph 1110 as an example. The explanatory graph 1110 illustrates an example of a graph 1111 of the graph representation G_{I} of the input sentence 103, a graph 1112 of the graph representation G₁ of the first template, and a graph 1113 of a graph representation G₂ of the second template.

In the graph 1112, the number of extra edges is larger by 2 and the number of necessary edges is smaller by 1 than the graph 1111. Therefore, when ½ times of the sum of the absolute values of the respective elements of the difference (G_{I}−G₁) between the graph representation G_{I} of the graph 1111 and the graph representation G₁ of the graph 1112 is calculated, the distance is calculated as “3”. Since the graph 1113 requires one less edge than the graph 1111, when ½ times the sum of the absolute values of the respective elements of the difference (G_{I}−G₂) between the graph representation G_{I} of the graph 1111 and the graph representation G₂ of the graph 1113 is calculated, the distance is calculated as “1”. Here, even if the first template is a correct correction (template) for an erroneous input, in a simple subtraction, when there is an extra service in between, it is determined that the similarity is low. In order to solve this problem, it is necessary to reflect the reachability from a certain service to a certain service in the index. For example, since a node T can reach a node U via a node V, the graph is processed such that it is determined that the graph 1112 is at least equidistant from the graph 1113 when the node T passes through an extra service (node V).

More specifically, the processing unit 214 performs the processing in steps S1101 to S1104 on the graph representation G of all the templates in the template group 101 and on all sets of services {A, B} having a connection relationship in the graph representation G_{I} of the input sentence 103 and not having a connection relationship in the graph representation G_{K}. For example, the processing unit 214 performs the processing in steps S1101 to S1104 on a pair of services (the node T and the node U in the graph 1111) having the node T and the node U as the start point and the end point in the connection relationship in the graph 1112 of the input sentence 103 and not in the direct connection relationship in the graph 1112 of the first template.

In step S1101, the processing unit 214 searches for a route that can reach from “A” to “B”. In this example, the processing unit 214 searches for the route “node T-node V-node U”.

In step S1102, the processing unit 214 determines whether “B” can be reached from “A”. In a case where it is determined that “B” can be reached from “A”, the processing unit 214 moves the processing to step S1103, and in a case where it is determined that “B” cannot be reached from “A”, the processing unit 214 moves the processing target next. In this example, the processing unit 214 determines that the node U can be reached from the node T, and moves the processing to step S1103.

In step S1103, the processing unit 214 divides the weight of the edge of the route by the number of nodes (services) having passed. More specifically, the processing unit 214 sets the weight of the edge in the section as [1/number of edges] and updates the graph representation G_{K} of the processing target. In this example, since the number of passed edges is “2”, the processing unit 214 sets the weight of the edge between the node T and the node V to “0.5” and the weight of the edge between the node V and the node U to “0.5”.

In step S1104, the processing unit 214 subtracts an edge with a weight “1” from “A” and “B”, and updates the graph representation G_{K} to be processed. In this example, the processing unit 214 connects the node T at the start point and the node U at the end point with the edge of the weight “1”, and sets “1” to the corresponding element of the graph representation G_{K}.

With the above processing, the graph 1112 with the extra node V in between is processed as in a graph 1120 and the graph representation G of the graph 1112 is updated to show the graph 1120.

FIG. 12 is a diagram illustrating an example of similarity ranking derivation processing. Since the adjacent matrix (graph representation) is obtained from the input sentence 103 by the user and the template in the template group 101, the template having the highest similarity is searched by comparing the input sentence 103 and the template in the similarity ranking derivation processing. In this example, as the score indicating the similarity between the graph representation G_{I} of the input sentence 103 and the graph representation G_{K} of the template, ½ times the sum of the absolute values of the differences (G_{I}−G_{K}) of the respective elements is calculated.

More specifically, the search unit 215 performs the processing of steps S1201 and S1202 on the graph representation G_{K} of all the templates.

In step S1201, the search unit 215 calculates a difference (G_{I}−G_{K}) between the graph representation G_{I} of the input sentence 103 and the graph representation G_{K} of the template to be processed.

In step S1202, the search unit 215 calculates the sum of the absolute values of the respective elements of (G_{I}-G_{K}) and multiplies the calculated sum by ½. The more the graphs match, the closer ½ times the sum of the absolute values of the respective elements of (G_{I}−G_{K}) is close to “0”. Note that a score (dissimilarity) between G_{I} and G_{K} is ½ times the sum of the absolute values of the respective elements. The smaller the value ½ times the sum of the absolute values of the respective elements is, the more consistent the score is. In the example of a graph 1210, the score is calculated as dist (G_{I}, G_{K})=2.

In step S1203, the search unit 215 sorts the templates in ascending order according to the score. The search unit 215 specifies the template of the graph representation G_{K} having the smallest score as the template (similar template 104) having the highest similarity.

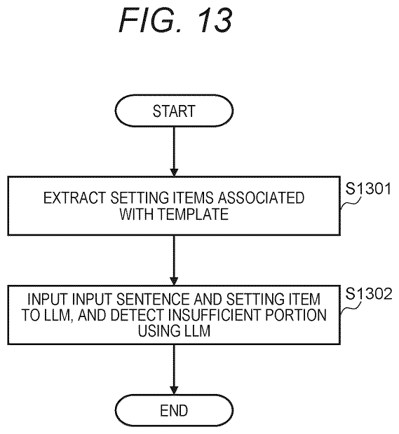

FIG. 13 is a diagram illustrating an example of necessary input information acquisition processing.

In step S1301, the output unit 216 extracts the necessary setting item 105 (setting item associated with the similar template 104) from the setting item group 102.

In step S1302, the output unit 216 inputs the prompt 106 for requesting detection of an insufficient portion of the input sentence 103 to the LLM251 based on the input sentence 103 and the necessary setting item 105, and detects the insufficient portion of the input sentence 103 using the LLM251. The LLM251 generates the correction proposal sentence 107 based on the received prompt 106, and replies the generated correction proposal sentence 107 to the output unit 216. Note that the prompt 106 to be input to the LLM251 will be described with reference to FIG. 15.

FIG. 14 is a diagram illustrating an example of the input sentence 103 (input sentence 1400).

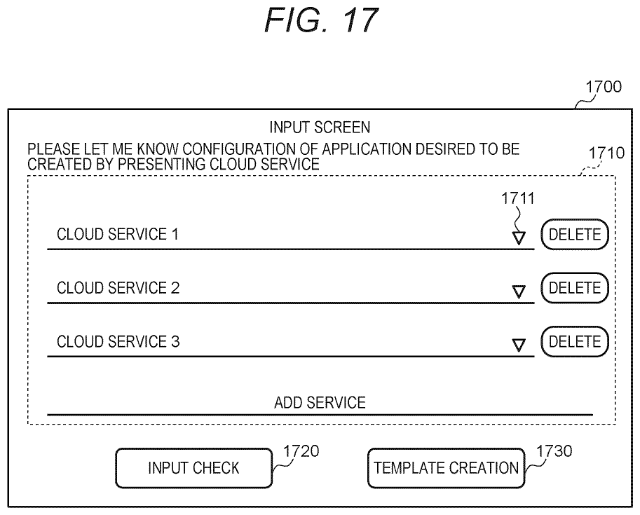

The input sentence 1400 includes information in which a service name 1401, a service ID 1402, and a description 1403 are associated with each other. The information of the input sentence 1400 is input via, for example, the user interfaces illustrated in FIGS. 17 to 19. In the service name 1401, a name indicating a service is input. A code allocated to identify the service is input to the service ID 1402. A description of the service is input to the description 1403. The description of the service may include a service name and/or a service ID of another service related to the service.

FIG. 15 is a diagram illustrating an example of the prompt 106 (prompt 1500) for requesting the LLM251 to detect an insufficient portion of the input sentence 103.

The prompt 1500 is generated by the output unit 216 and input to the LLM251. The prompt 1500 includes an instruction 1510-1 for requesting the input sentence 103 to detect an insufficient setting item, a content 1520 of the input sentence 103, and a content 1530 of a setting item (necessary setting item 105) associated with the similar template 104. Note that the content 1520 of the input sentence 103 and the content 1530 of the necessary setting item 105 may be provided for each service, or may be provided in association with service information (Service name, service ID, etc.). In addition, the prompt 1500 preferably includes an instruction 1510-2 for requesting to output information (input example, reference information, etc.) for supporting the user when inputting an insufficient setting item in the input sentence 103.

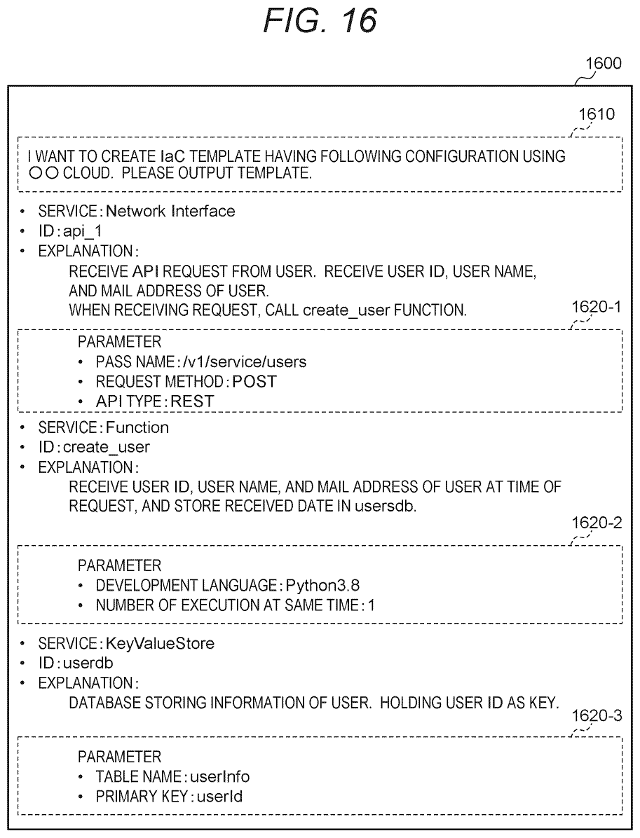

FIG. 16 is a diagram illustrating an example of the prompt 108 (prompt 1600) for requesting the LLM251 to generate the proposal template 109.

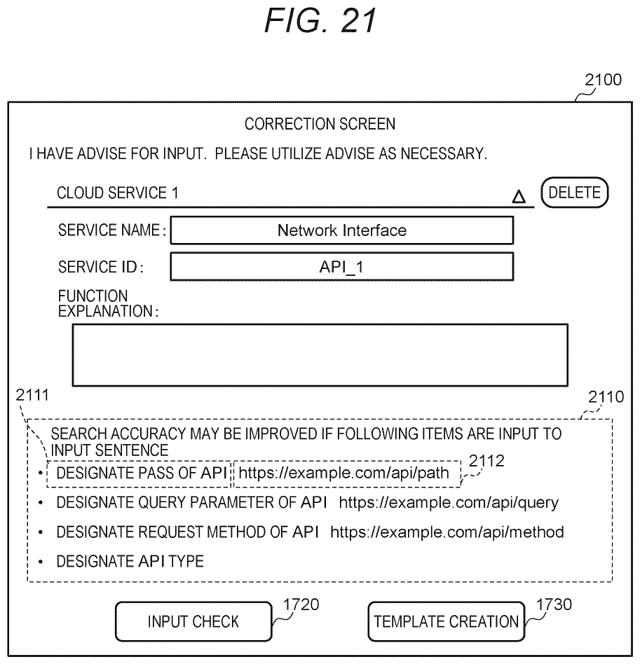

The prompt 1600 is an example of the prompt including the content in which the input sentence 103 is corrected by the user based on the correction proposal sentence 107. The prompt 1600 is input, for example, through the user interface shown in FIGS. 20 and 21. The prompt 1600 includes an instruction 1610 for requesting the LLM251 to output the proposal template 109, the content of the input sentence 103, and the content 1620 reflecting the insufficient portion such as the parameter indicated in the correction proposal sentence 107. Note that the instruction 1610 may be generated by the output unit 216 or may be input by the user.

FIG. 17 is a diagram illustrating an example of a user interface (input screen 1700).

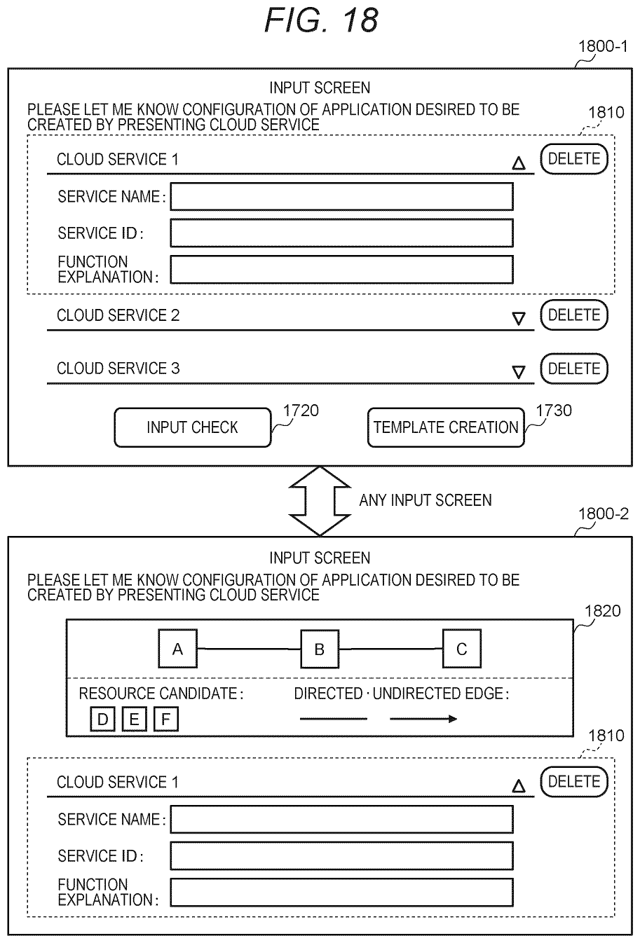

The input screen 1700 is a screen displayed on the user terminal 120, and is an example of an initial screen for inputting the input sentence 103. The input screen 1700 is provided with an input field 1710 for inputting information of a service used for a desired system, an input check button 1720 for confirming contents input by the user, and a template creation button 1730 for outputting the proposal template 109. In the input field 1710, for each service, an expansion/collapse button 1711 for expanding or collapsing details of the service is provided. When the expansion/collapse button 1711 is pressed, an input field for inputting details of the service is displayed. FIG. 18 is a diagram illustrating an example of a user interface (input screen 1800).

The input screen 1800 is an example of a screen displayed on the user terminal 120 when the expansion/collapse button 1711 is pressed by the user on the input screen 1700. The input screen 1800 is provided with an input field 1810 for inputting a service name of a service that the user desires to use, a service ID of the service, and a description (function description) of the service.

As the input screen 1800, an input screen 1800-1 or an input screen 1800-2 can be employed. A difference between the input screen 1800-1 and the input screen 1800-2 is presence or absence of an input field 1820 for inputting an architecture diagram. In the input field 1820, the user can create a graph (directed graph or undirected graph). When the graph is created by the user, the processing of graphing the natural language can be omitted.

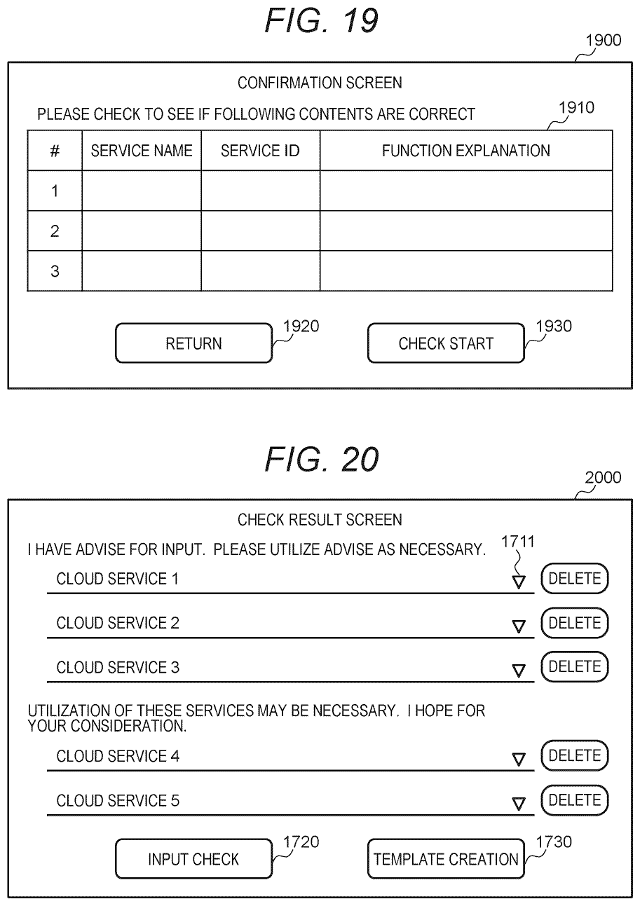

FIG. 19 is a diagram illustrating an example of a user interface (confirmation screen 1900).

The confirmation screen 1900 is an example of a screen displayed on the user terminal 120 when the user inputs information of a service used for a desired system on the input screen 1800 and presses the input check button 1720. The confirmation screen 1900 is provided with a confirmation field 1910 for confirming the input contents, a return button 1920 for returning to the input screen 1700 or the input screen 1800, and a check start button 1930 for outputting the correction proposal sentence 107.

FIG. 20 is a diagram illustrating an example of a user interface (check result screen 2000).

The check result screen 2000 is an example of a screen displayed on the user terminal 120 when the check start button 1930 is pressed by the user on the confirmation screen 1900. The check result screen 2000 can display the correction proposal sentence 107 generated by the LLM251. On the check result screen 2000, the user presses the expansion/collapse button 1711 to refer to specific advice for each service.

FIG. 21 is a diagram illustrating an example of a user interface (correction screen 2100).

The correction screen 2100 is an example of a screen displayed on the user terminal 120 when the expansion/collapse button 1711 is pressed by the user on the check result screen 2000. On the correction screen 2100, a confirmation field 2110 for confirming the correction proposal sentence 107 of the service corresponding to the pressed expansion/collapse button 1711 is displayed. In the confirmation field 2110, a content 2111 of the insufficient portion indicating the insufficient setting item in the input sentence 103 and an access information 2112 for accessing the site that serves as a reference when the user inputs the content 2111 of the insufficient portion are displayed. The access information 2112 may be generated by the LLM251, or may be registered by a person who constructs the template creation support system 110, a skilled person, or the like in the necessary input information storage processing (step S602).

According to the present embodiment, two different abstraction levels and forms, that is, an input in natural language and a template in a computer language are converted into a comparable form called a graph (adjacent matrix), and a difference is extracted, so that similarity can be compared. Accordingly, it is possible to effectively search an existing template having a service configuration similar to the service configuration desired to be realized by the user. It is possible to prevent the user from inputting an ambiguous prompt to the LLM by complementing the information based on the template hit by the search. Therefore, the accuracy of template creation using the LLM is improved, which can contribute to user productivity.

Furthermore, according to the present embodiment, it is possible to effectively support the creation of the template by representing the input necessary for the LLM to the user. As a result, even a user who has little knowledge about a plurality of independent services provided by a cloud vendor can perform detailed input, so that a prompt with a larger information amount can be created, and as a result, a template with higher accuracy can be obtained by the LLM.

In addition to this, the user can also notice the presence of resources that were not noticed at the time of initial requirement input. In particular, resources such as logs and authority settings that are implicitly created at the time of operation on the cloud console tend to be overlooked by users who are inexperienced. Such omissions in resource definition can be found by searching for similar templates.

### (II) Appendix

The above-described embodiment includes, for example, the following contents.

In the above-described embodiment, a case where the present invention is applied to the template creation support system has been described, but the present invention is not limited thereto, and can be widely applied to other various systems, devices, methods, and programs.

In the above-described embodiment, the correction proposal sentence 107 is output according to the input sentence 103. However, the present disclosure is not limited to this. For example, the similar template 104 or the necessary setting item 105 may be output according to the input sentence 103.

Furthermore, in the above-described embodiment, the case where the access information 2112 is presented on the correction screen 2100 has been described, but the present invention is not limited thereto. For example, in addition to or instead of the access information 2112, a corresponding portion of the similar template 104 may be presented, or an input example of an insufficient portion (setting item) may be presented.

Further, in the above-described embodiment, a case where the template conversion processing is executed at the time of constructing the template creation support system 110 has been described, but the present invention is not limited thereto. For example, the template conversion processing may be executed at an appropriate timing before the similarity ranking derivation processing (step S904).

Further, in the above-described embodiment, some or all of the programs may be installed from a program source into a device such as a computer that implements the template creation support system. The program source may be, for example, a program distribution server connected by network or a recording medium readable by a computer (for example, a non-transitory recording medium). Further, in the above description, two or more programs may be implemented as one program, or one program may be implemented as two or more programs.

Further, in the above-described embodiment, the configuration of each table is an example, and one table may be divided into two or more tables, or all or a part of two or more tables may be one table.

Further, in the above-described embodiment, for convenience of description, the information related to the template creation support system has been described using the table, but the data structure is not limited to the table. The information related to the template creation support system may be expressed by a data structure other than a table, such as extensible markup language (XML), YAML, a hash table, or a tree structure.

Furthermore, in the above-described embodiment, the screen illustrated and described is an example, and any design may be used as long as the received information is the same.

Furthermore, in the above-described embodiment, the screen illustrated and described is an example, and any design may be used as long as information to be presented is the same.

Furthermore, in the above-described embodiment, the output of information is not limited to display on a display. The output of the information may be audio output by a speaker, may be output to a file, may be printing on a paper medium or the like by a printing device, may be projection on a screen or the like by a projector, or may be another mode.

Furthermore, in the above-description, information such as a program, table, and file that realizes each function can be stored in a recording device such as a memory, hard disk, a Solid state drive (SSD), or a recording medium such as an IC card, SD card, or DVD.

The above-described embodiment has, for example, the following characteristic configurations.

(1)

A template creation support system (for example, the template creation support system 110, the cloud system) that supports creation of a template dependency relationship for a resource of one service among a plurality of available services to call a resource of another service is set, the template creation support system including: a memory unit (for example, the storage service unit 230 and the storage device) that memorizes information of a template group (for example, the template group 101) in which one or more resources provided in each of the plurality of services are set, the template group collecting templates guaranteed to operate; a first conversion unit (for example, the compute service unit 210, the template conversion unit 211, and the computer) that converts each template of the template group into a graph including a node indicating a service and an edge indicating a relationship between services based on the dependency relationship between the set resources; an input unit (for example, the compute service unit 210, the input unit, or the computer) that receives an input including information indicating a system configuration desired by a user and an operation of each component from a user terminal (for example, the user terminal 120); a second conversion unit (for example, the compute service unit 210, the input conversion unit 213, and the computer) that converts the input received by the input unit into a graph including a node indicating a service and an edge indicating a relationship between services; a search unit (for example, the compute service unit 210, the search unit 215, and the computer) that searches, from the template group, a template of a graph close to the graph converted by the second conversion unit from among the graphs converted by the first conversion unit; and an output unit (for example, the compute service unit 210, the output unit 216, and the computer) that outputs a setting item set in the template searched by the search unit.

According to the above configuration, the setting item used to create the template can be presented to the user. As a result, even a user with shallow knowledge of resources can grasp necessary setting items, and thus, for example, a prompt with a larger amount of information for obtaining a template is created by the user, and as a result, a template with higher accuracy can be obtained by the LLM.

(2)

The template creation support system is communicably connected to an artificial intelligence system (the generation AI system 130, the LLM 251) that generates an answer in response to a prompt, and further includes a storage unit (the compute service unit 210, the storage unit 212, the computer) that stores information of a setting item group (for example, the setting item group 102) in which a setting item set in each template of the template group is registered for each service, wherein the output unit extracts, for each service, a setting item associated with the template searched by the search unit from the setting item group, inputs, to the artificial intelligence system, a prompt to output, for each service, an insufficient portion of an insufficient setting item for the input received by the input unit based on the extracted setting item, and transmits the insufficient portion for each service output from the artificial intelligence system to the user terminal (see, for example, see steps S113 to S115, steps S905 and S906).

According to the above configuration, for example, even in a case where there are a large number of setting items for one service, the user can easily grasp the insufficient portion by eliminating the setting items input by the user from among the setting items.

(3)

The output unit transmits, to the user terminal, access information (for example, the access information 2112) for accessing a site that serves as a reference for correction of the insufficient portion output from the artificial intelligence system together with the insufficient portion.

According to the above configuration, for example, even in a case where the user does not know how to correct the insufficient portion generated by the LLM, the user can easily access the site serving as a reference for correcting the insufficient portion, so that the insufficient portion can be appropriately corrected.

(4)

The first conversion unit sets a weight of an edge to an element having a dependency relationship in G_{K}, which is an adjacent matrix of the template storing information of the graph, based on a dependency relationship between nodes of the graph obtained by converting the template for each template of the template group (see, for example, steps S701 to S703), the second conversion unit sets a weight of an edge to an element having a dependency relationship in G_{I}, which is an adjacent matrix of the input storing information of the graph, based on a dependency relationship between nodes of the graph obtained by converting the input received by the input unit (see, for example, steps S1001 to S1003), and the search unit calculates a similarity from a difference between G_{I} and G_{K} for the graph of each template of the template group converted by the first conversion unit and the graph converted by the second conversion unit, and searches a template of a graph of G_{K} having the highest similarity from the template group (for example, a score that is ½ times the sum of the absolute values of the differences between G_{I} and G_{K} is calculated, and a template of a graph of G_{K} having the smallest calculated score is searched from the template group; see steps S1201 to S1203).

According to the above configuration, for example, the template of the graph most similar to the graph whose input is converted can be searched from the template group.

(5)

The template creation support system includes a processing unit (for example, the compute service unit 210, the processing unit 214, and the computer) that processes information of the graph converted by the first conversion unit, in which in a case where there is a connection relationship between a first node and a second node of the graph whose input has been converted by the second conversion unit, and there is no connection relationship between the first node and the second node of the graph whose template has been converted by the first conversion unit, the processing unit searches a route that can reach the second node from the first node in the graph into which the template has been converted, and when a reachable route is searched, the processing unit processes G_{K} of the template so that an extra node is included in the route and similarity (for example, a score) of the graph becomes the same as similarity (for example, a score) of the graph having no extra node between the first node and the second node.

When an operation is performed on the cloud console, resources such as logs and authority settings that are created implicitly tend to be overlooked by users who are inexperienced. According to the above configuration, for example, in a case where a template having an extra service therebetween is correct correction for an erroneous input, it is possible to avoid a situation in which it is determined that the similarity is low by simple subtraction, and thus, it is possible to detect omission of the definition of the implicitly created resource.

(6)

G_{K} of each template of the template group and G_{I} of the input received by the input unit are adjacent matrices (for example, the adjacent matrix 720 and the adjacent matrix 1010) having nodes indicating the plurality of services as rows and columns.

According to the above configuration, since the sizes of G_{K} and G_{I} are determined, it is possible to perform graphing by the first conversion unit before an input is received by the input unit, for example, at the time of constructing the template creation support system.

In addition, the above-described configuration may be appropriately changed, rearranged, combined, or omitted without departing from the gist of the present invention.

### REFERENCE SIGNS LIST

101 template group
102 setting item group
103 input sentence
110 template creation support system

1. A template creation support system that supports creation of a template in which a dependency relationship for a resource of one service among a plurality of available services to call a resource of another service is set, the template creation support system comprising:
a memory unit that memorizes information of a template group in which one or more resources provided in each of the plurality of services are set, the template group collecting templates guaranteed to operate;
a first conversion unit that converts each template of the template group into a graph including a node indicating a service and an edge indicating a relationship between services based on the dependency relationship between the set resources;
an input unit that receives an input including information indicating a system configuration desired by a user and an operation of each component from a user terminal;
a second conversion unit that converts the input received by the input unit into a graph including a node indicating a service and an edge indicating a relationship between services;
a search unit that searches, from the template group, a template of a graph close to the graph converted by the second conversion unit from among the graphs converted by the first conversion unit; and
an output unit that outputs a setting item set in the template searched by the search unit.

2. The template creation support system according to claim 1, which is communicably connected to an artificial intelligence system that generates an answer in response to a prompt, the template creation support system further comprising a storage unit that stores information of a setting item group in which a setting item set in each template of the template group is registered for each service, wherein
the output unit extracts, for each service, a setting item associated with the template searched by the search unit from the setting item group, inputs, to the artificial intelligence system, a prompt to output, for each service, an insufficient portion of an insufficient setting item for the input received by the input unit based on the extracted setting item, and transmits the insufficient portion for each service output from the artificial intelligence system to the user terminal.

3. The template creation support system according to claim 2, wherein the output unit transmits, to the user terminal, access information for accessing a site that serves as a reference for correction of the insufficient portion output from the artificial intelligence system together with the insufficient portion.

4. The template creation support system according to claim 1, wherein
the first conversion unit sets a weight of an edge to an element having a dependency relationship in G_{K}, which is an adjacent matrix of the template storing information of the graph, based on a dependency relationship between nodes of the graph obtained by converting the template for each template of the template group,
the second conversion unit sets a weight of an edge to an element having a dependency relationship in G_{I}, which is an adjacent matrix of the input storing information of the graph, based on a dependency relationship between nodes of the graph obtained by converting the input received by the input unit, and
the search unit calculates similarity from a difference between G_{I} and G_{K} for the graph of each template of the template group converted by the first conversion unit and the graph converted by the second conversion unit, and searches a template of a graph of G_{K} having the highest similarity from the template group.

5. The template creation support system according to claim 4, further comprising a processing unit that processes information of the graph converted by the first conversion unit, wherein
in a case where there is a connection relationship between a first node and a second node of the graph whose input has been converted by the second conversion unit, and there is no connection relationship between the first node and the second node of the graph whose template has been converted by the first conversion unit, the processing unit searches a route that can reach the second node from the first node in the graph into which the template has been converted, and when a reachable route is searched, the processing unit processes G_{K} of the template so that an extra node is included in the route and similarity of the graph becomes a same as similarity of the graph having no extra node between the first node and the second node.

6. The template creation support system according to claim 4, wherein
G_{K} of each template of the template group and G_{I} of the input received by the input unit are adjacent matrices having nodes indicating the plurality of services as rows and columns.

7. A template creation support device that supports creation of a template in which a dependency relationship for a resource of one service among a plurality of available services to call a resource of another service is set, the template creation support device comprising:
a memory unit that memorizes information of a template group in which one or more resources provided in each of the plurality of services are set, the template group collecting templates guaranteed to operate;
a first conversion unit that converts each template of the template group into a graph including a node indicating a service and an edge indicating a relationship between services based on the dependency relationship between the set resources;
an input unit that receives an input including information indicating a system configuration desired by a user and an operation of each component from a user terminal;
a second conversion unit that converts the input received by the input unit into a graph including a node indicating a service and an edge indicating a relationship between services;
a search unit that searches, from the template group, a template of a graph close to the graph converted by the second conversion unit from among the graphs converted by the first conversion unit; and
an output unit that outputs a setting item set in the template searched by the search unit.

8. A template creation support method for supporting creation of a template in which a dependency relationship for a resource of one service among a plurality of available services to call a resource of another service is set, the template creation support method comprising:
memorizing, information of a template group in which one or more resources provided in each of the plurality of services are set by a memory unit, the template group collecting templates guaranteed to operate;
converting, by a first conversion unit, each template of the template group into a graph including a node indicating a service and an edge indicating a relationship between services based on the dependency relationship between the set resources;
receiving, by an input unit, an input including information indicating a system configuration desired by a user and an operation of each component from a user terminal;
converting, by a second conversion unit, the input received by the input unit into a graph including a node indicating a service and an edge indicating a relationship between services;
searching, by a search unit, from the template group, a template of a graph close to the graph converted by the second conversion unit from among the graphs converted by the first conversion unit; and
outputting, by an output unit, a setting item set in the template searched by the search unit.
